(19) United States
(12) Patent Application Publication
(10) Pub. No.: US 2004/0060150 A1
(43) Pub. Date: Apr. 1, 2004

(54) Door jig assembly for use during manufacture of a vehicle

(76) Inventor: Jeffrey C. Krozek, Harrison Township, MI (US)

Correspondence Address: GIFFORD, KRASS, GROH, SPRINKLE, ANDERSON & CITKOWSKI, PC, 280 N OLD WOODARD AVE, SUITE 400, BIRMINGHAM, MI, 48009, US

(21) Appl. No.: 10/261,339

(22) Filed: Sep. 30, 2002

(51) Int. Cl. E05F 5/06

(52) U.S. Cl. 16/86 C

(57) ABSTRACT

A door jig assembly for use with a vehicle, the vehicle including a door having an inner facing edge and which is hingedly connected to a vehicle pillar forming a part of a vehicle door frame. The door is further capable of being pivoted about the hinges and between opened and closed positions relative to the pillar. The jig assembly has an elongated body with a first end pivotally secured to the vehicle pillar. A pin pivotally secures to the inner facing edge of the vehicle door and translates in guided fashion in one of first and second directions along the elongated body and upon opening and closing the door. A spring biasing cage portion is disposed at an intermediate location along the elongated body and which, upon rotating the vehicle door to the closed position, establishes a specified holding force of the door against the vehicle frame. Spring deflecting portions extend along a predetermined length of the body towards a second end, the spring deflecting portions corresponding to a travel direction of the pin and which, upon opening of the door, exerts an increasing retaining force against the door.

### BACKGROUND OF THE INVENTION

1. Field of the Invention

The present invention relates generally to door opening and closure assemblies, such as those which are particularly employed in vehicles. More specifically, the present invention discloses a door detent, or jig, assembly which is temporarily installed upon a vehicle during its manufacturing, and which functions to establish a selected holding force in either or both a closed or opened position of the hingedly attached door relative to the vehicle pillar. The jig assembly further maintains the door in the desired position (open or closed) during the various manufacturing steps performed in the vehicle as it is translated along the vehicle assembly line and in spite of any accidental or unanticipated contact forces occurring during such assembly.

2. Description of the Prior Art

The prior art is well documented with examples of door checking and door closure mechanisms, most particularly those employed in vehicle doors. Such door checking mechanisms are typically installed in the completed vehicle, forming a permanent part thereof, and a first example of this is set forth in U.S. Pat. No. 5,173,991, issued to Carswell ('991) which teaches such a component which forms a permanent part of the vehicle door structure. In particular, the closure mechanism is moveable in relation to the frame and includes a housing affixed to the closure member or the frame and having an opening defined therethrough.

A link member in Carswell is fastened either to the frame or the closure member and is moveable in relation to the housing by passing through the opening. Link engaging means secure with the housing proximate the opening proximate at least one side of the link member and include at least one compatible groove formed proximate at least one side of the link member for positioning the link member in relation to the housing, the grooves of the link member being formed by coating the core thereof with a moldable material prior to assembly of the checking mechanism.

An additional example of a door check assembly is disclosed in Koch, U.S. Pat. No. 6,178,594, and which teaches an elongated body having side walls defining a channel and an energy absorber. When mounted to a door, a pivot pin is inserted through an opening at the first end of the elongated body and a slide pin extends through the channel. The pivot pin is attached to the door and the slide pin attached to structure (pillar) adjacent the door. As the door is opened, the elongated body moves relative to the slide pin to position the slide pin toward the second end portion of the elongated body. The slide pin may be positioned in any one of one or more stop positions which yieldably hold the slide pin. If the door is opened beyond its normal opening arc, the energy absorber is engaged and resists further movement of the door.

An older design of a stay mechanism, similar to Koch's, is disclosed in U.S. Pat. No. 3,392,997, issued to Seckerson et al., and teaches an elongated strap with resilient limbs joined at one end by a substantially flat plate and at the other end by a substantially flat web. In the preferred application, Seckerson teaches a stay arm for holding the bonnet of a rear-engined vehicle in the open position.

U.S. Pat. No. 4,380,848, issued to Guionie, teaches a stop device for a pivotal door which teaches a fixed roller mounted in a bracket member fixed to the fixed post of the door. The arm is applied against the roller and, under the effect of a movable roller mounted on the bracket member, is biased into contact with the arm by a torsion spring which has two windings which are disposed synmmetrically on each side of branches of the bracket member.

### SUMMARY OF THE PRESENT INVENTION

As described previously, the present invention discloses a door detent, or jig, assembly which is temporarily installed upon a vehicle during its manufacturing, such as prior to the installation of a door checking mechanism as disclosed in the prior art, and which functions to establish a selected holding force in either or both a closed or opened position of the hingedly attached door relative to the vehicle pillar. The door jig assembly substitutes for earlier attempts to maintain the vehicle door in the closed position, such including the taping of the door in the closed position, such as during its conveyance along the vehicle assembly line. As further discussed, the jig assembly maintains the door in the desired position during the various manufacturing steps (such as again closed during conveyance of the vehicle along the assembly line and open during painting operations and the like) performed in the vehicle as it is translated along the vehicle assembly line and in spite of any accidental or unanticipated contact forces occurring during such assembly.

The jig assembly is provided as an elongated body constructed of a stamped spring steel material and having a first end and a second end. A tab hingedly secures to the first end of the elongated body and is fixedly engaging to the vehicle pillar. A pin assembly includes a pair of extending mounting studs, pivotally secured at corresponding locations to the inner facing edge of the vehicle door, and so that a pin extending therebetween is translatable in guided fashion in one of first and second directions along the elongated body and upon opening and closing of the door.

The elongated body also includes a pair of first and second elongate extending straps which overlap at a first location proximate to a spring biasing cage portion disposed at an intermediate location along the elongated body. Upon rotating the vehicle door to the closed position, the pin is translated through said first overlapping location and comes to rest within a seating location which exerts a specified holding force of the door against the vehicle frame. The straps further overlap at a second location extending along a predetermined length of the elongated body towards the second end, the straps defining spring deflecting portions corresponding to a travel direction of the translatable pin and which, upon progressive opening of the door, exerts an increasing retaining force against the door.

### BRIEF DESCRIPTION OF THE DRAWINGS

Reference will now be made to the attached drawings, when read in combination with the following detailed description, wherein like reference numerals refer to like parts throughout the several views, and in which:

FIG. 1 is a perspective view of the door jig assembly according to a preferred embodiment of the present invention;

FIG. 2 is an overhead view of the door jig assembly as shown in FIG. 1 and further illustrating the pivotally securing nature of the first end of the jig assembly to the vehicle pillar, as well as that of the translatable pin secured to the inside facing edge of the vehicle door and further showing spatially arrayed seating locations defined along the jig assembly;

FIG. 3 is a rotated side view of the door jig assembly and again illustrating the combined pivoting and translating aspects of the door mounted pin, as well as again the pivotally securing nature of the pillar end connection;

FIG. 4 is an enlarged sectional view illustrating the spring biasing cage portion, disposed at an intermediate location of the elongated jig assembly and which, upon rotating the vehicle door to a closed position, establishes a specified holding force; and

FIG. 5 is an operative view of the door jig assembly secured to the vehicle and illustrating both closed and opened positions of the door.

### DESCRIPTION OF THE PREFERRED EMBODIMENTS

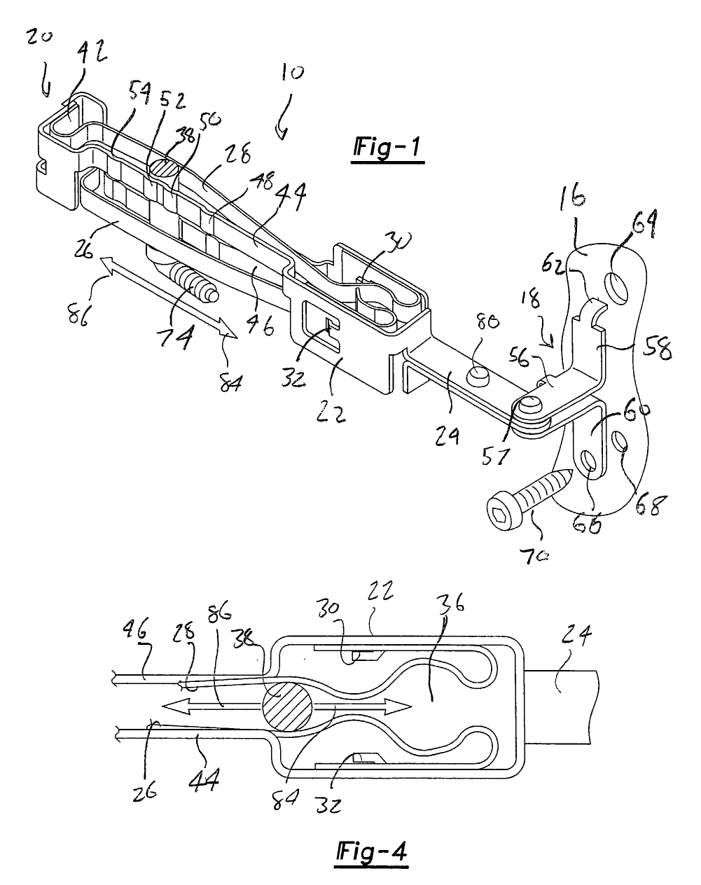

Referring now to FIGS. 1-5, a door jig assembly is illustrated at 10 according to a preferred embodiment of the present invention. As again previously explained, the jig (or detent) assembly is intended to be temporarily installed upon a vehicle during its manufacturing, such as prior to the installation of a door checking mechanism as exemplarily disclosed in the prior art, and which functions to establish a selected holding force in either or both a closed or opened position of the hingedly attached door relative to the vehicle pillar. As further discussed, the jig assembly maintains the door in the desired position (such as closed) during the various manufacturing steps performed in the vehicle as it is translated along the vehicle assembly line and in spite of any accidental or unanticipated contact forces occurring during such assembly.

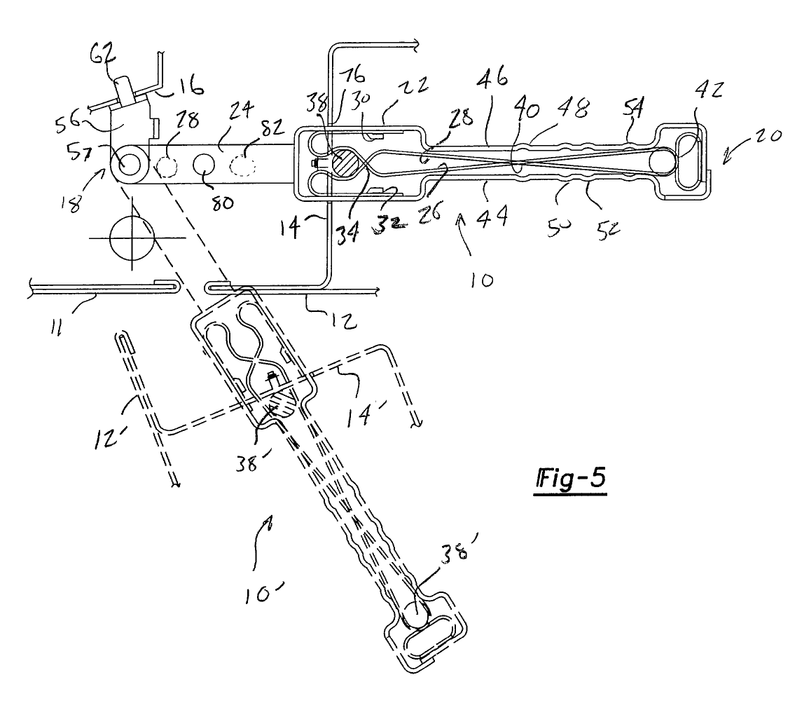

As best illustrated in FIG. 5, the vehicle is referenced at 11 and includes a door, see also graphically illustrated at 12. The door 12 exhibits an inner facing edge 14 and which is hingedly connected (not illustrated but conventionally known in the art) to a vehicle door frame, this further being exhibited by pillar 16 (see also FIG. 1). As is further illustrated in phantom in FIG. 5, the door is rotated to a substantially open position, see at 12′, as shown and by which it is understood how the door hinges interact with the door assembly.

Referring again to the various figures, the jig assembly 10 is constructed as an elongated body having a first end 18 and a second end 20. In the preferred embodiment, the jig assembly 10 is constructed of a stamped spring steel material exhibiting a Rockwell hardness rating of 52. However, it is understood that the material composition and overall shaping of the jig assembly can be modified without departing from the scope of the invention.

The elongated body of the jig assembly 10 further includes a substantially centralized and rectangular cage portion 22, this defining a spring biasing cage portion. A flattened mounting bracket 24 extends from one side of the cage portion 22 towards the first end 18 and a pair of elongated strap portion 26 and 28 which secure at first locations to inside locations of the spring cage 22 (see bent tab portions at 30 and 32, respectively, defined along the inner facing sides of the cage 22 and which secure thereto the configured ends of the strap portions 26 and 28).

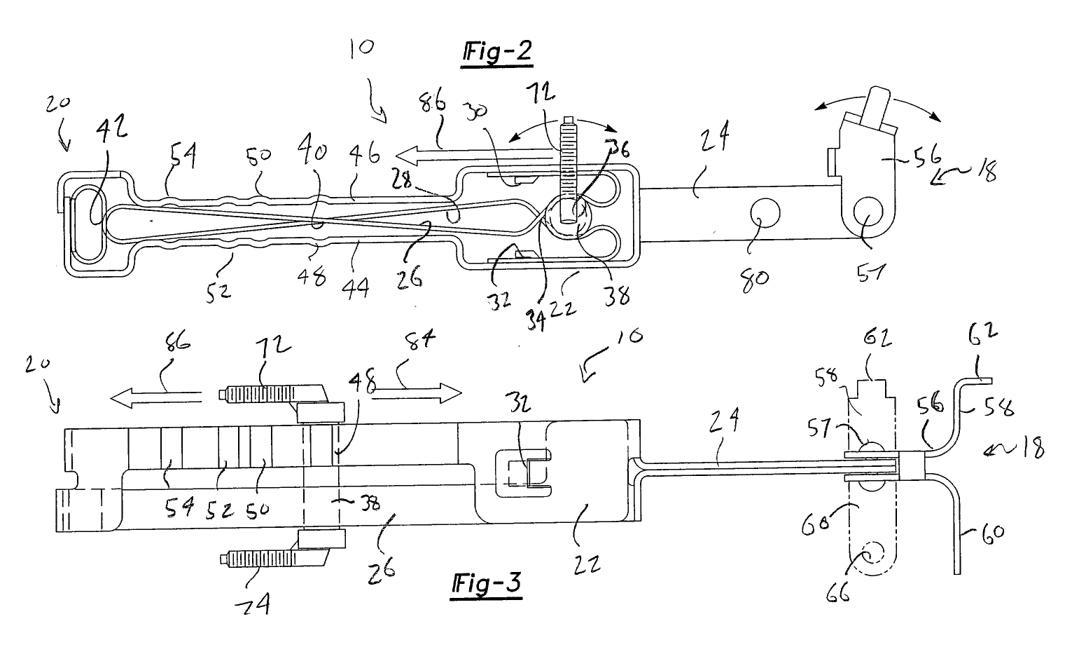

As is further best shown in FIGS. 2 and 5, the first and second straps 26 and 28 overlap at a first location 34 within the spring biasing cage 22, the straps subsequently diverging to define a seating location, see at 36 in FIGS. 2 and 4, for a pin 38 associated with the jig assembly in the door closed position. The straps 26 and 28 overlap at a second location 40 (see FIGS. 2 and 5) and along a predetermined length of the elongated body towards the second end 20 prior to being anchored at the second end, see at 42, in the manner illustrated.

Additional to the straps 26 and 28, arcuate extending body portions 44 and 46 extend between the spring cage 22 and the second end 20. A plurality of opposing and undulating portions, see at 48, 50, 52 and 54, are defined at locations along the predetermined length of the body portions 44 and 46 and define additional seating locations of the pin 38 in the door opening direction, the pin being further illustrated in a fully opened seating position 38′ commensurate with the door being fully opened, see further at 12′, relative to the hinges and door pillar 16.

A tab 56 is pivotally secured to the first end 18 of the elongated body, see hinged connection 57. The tab 56 includes a pair of oppositely angled engaging portions, defined at 58 and 60. The first engaging portion 58 terminates in an angled detent 62 which seats within an associated aperture 64 defined in the door pillar 16 (see again FIG. 1). The second engaging portion 60 includes an aperture 66 define therethrough which, upon positioning, aligns with a further suitable aperture 68 defined at a further corresponding location of the door pillar 68 and which, upon positioning, receives an insertable screw 70 to fasten the tab 56. It is also understood that additional mounting assemblies, other than that described herein, can be employed for securing the pivotal tab to the door pillar 16.

The pin, previously identified at 38, defines part of an assembly which further includes a pair of first 72 and second 74 pivotally mounting studs extending from opposite ends of the pin 38. As again graphically illustrated in FIG. 5, and although not clearly shown, it is understood that the mounting studs 72 and 74 secure to first and second corresponding locations of the inner facing door edge 14 and so that the remaining extending length of the elongated body 10 may extend through an aperture 76 which has been pre-defined in the door edge 14. In this fashion, the rotating travel of the elongated body is not impeded with by the relative position of the door in either the opening or closing directions. As also shown in FIG. 5, an additional plurality of spaced apart apertures 78, 80 and 82 (of which 78 and 82 are illustrated only in phantom in this illustration) may be defined along the flattened mounting bracket 24. In this manner, the jig assembly 10 is capable of being mounted to a variety of different makes and model of vehicle and by which the hinged separation of the door, relative to the door pillar, may be affected.

In the preferred embodiment, and upon closing of the door 12 relative to the vehicle 11 (see in solid again in FIG. 5) the pin 38 is seated in the first location identified previously at 36, proximate the spring cage 22, and so that a specified door holding, or closing, force is applied to maintain the door in the closed position. In one preferred application, this door closing/holding force is rated at about 25 pounds per square inch (psi) holding pressure and so that, upon conveying the vehicle along the assembly line, the door is maintained shut in spite of angular orientations of the vehicle, along at least two axes as it is supported upon the vehicle assembly trolley, as well as resisting opening in response to accidental impacts of additional vehicles positioned fore and aft thereof.

Referring throughout the figures, directional arrows 84 and 86 indicate the travel of the pin 38 in directions corresponding to closing and opening of the door, respectively. As again shown in phantom in FIG. 5, a substantially fully opened position of the door 12′ is shown and in which the jig assembly 10′ is deflected so that the pin 38′ is seated in the fully opened location and further so that a fully increased holding force is exerted on the door. As discussed previously, intermediate locations along this extending length define varying holding (retaining) forces and which serve to hold the door open as desired during such manufacturing steps as painting or the like.

Having described my invention, additional preferred embodiments will become apparent to those skilled in the art to which it pertains and without deviating from the scope of the appended claims.

I claim:

1. A door jig assembly for use with a vehicle, the vehicle including a door having an inner facing edge and which is hingedly connected to a vehicle pillar forming a part of a vehicle door frame, the door further capable of being pivoted about the hinges and between opened and closed positions relative to the pillar, said jig assembly comprising:
an elongated body having a first end pivotally secured to the vehicle pillar;
a pin pivotally secured to the inner facing edge of the vehicle door and translatable in guided fashion in one of first and second directions along said elongated body and upon opening and closing of the door;
a spring biasing cage portion disposed at an intermediate location along the elongated body and which, upon rotating the vehicle door to the closed position, establishes a specified holding force of the door against the vehicle frame; and
spring deflecting portions extending along a predetermined length of said elongated body and towards a second end, said spring deflecting portions corresponding to a travel direction of said translatable pin and which, upon progressive opening of the door, exerts an increasing retaining force against the door.

2. The door jig assembly as described in claim 1, said spring deflecting portions further comprising first and second elongated and biasing straps extending between said spring biasing cage portion and said second end.

3. The door jig assembly as described in claim 2, further comprising said first and second straps overlapping at a first location within said spring biasing cage, said straps diverging subsequent to said first location to define a seating location of said pin in the door closed position.

4. The door jig assembly as described in claim 3, said straps overlapping at a second location along said predetermined length of said elongated body.

5. The door jig assembly as described in claim 1, further comprising a plurality of opposing and undulating portions defined at locations along said predetermined length of said elongated body, said undulating portions defining seating locations for said pin in the door opening direction.

6. The door jig assembly as described in claim 1, said first pivotally secured end further comprising a tab hingedly secured to said elongated body and fixedly engaged to the door pillar.

7. The door jig assembly as described in claim 6, further comprising a plurality of axially spaced apertures defined along said elongated body, proximate said first end, and defining additional and hingedly securing locations for said tab.

8. The door jig assembly as described in claim 1, said elongated body exhibiting a specified shape and size and being constructed of a stamped spring steel material.

9. The door jig assembly as described in claim 1, said elongated body exhibiting a specified shape and size and being constructed of Rockwell hardness number of 52.

10. The door jig assembly as described in claim 1, said elongated body exhibiting a specified shape and size and exerting a holding pressure of about 25 pounds per square inch in the door closed position.

11. The door jig assembly as described in claim 1, further comprising a pair of mounting studs extending from opposite ends of said guided pin, said studs being adapted to engage first and second locations of the inner facing door edge.

12. The door jig assembly as described in claim 11, an apertured portion being defined within the inner facing door edge, proximate said first and second engaging locations, and through which a selected portion of said elongated body extends.

13. A door jig assembly for use with a vehicle, the vehicle including a door having an inner facing edge and which is hingedly connected to a vehicle pillar forming a part of a vehicle door frame, the door further capable of being pivoted about the hinges and between opened and closed positions relative to the pillar, said jig assembly comprising:
an elongated body constructed of a stamped spring steel material and having a first end and a second end;
a tab hingedly securing to said first end of said elongated body and fixedly engaging to the vehicle pillar;
a pin assembly including a pair of extending mounting studs pivotally secured to the inner facing edge of the vehicle door and so that a pin extending therebetween is translatable in guided fashion in one of first and second directions along said elongated body and upon opening and closing of the door;
a spring biasing cage portion disposed at an intermediate location along the elongated body and which, upon rotating the vehicle door to the closed position, establishes a specified holding force of the door against the vehicle frame; and
spring deflecting portions communicating with said spring biasing cage portion and extending along a predetermined length of said elongated body towards said second end, said spring deflecting portions corresponding to a travel direction of said translatable pin and which, upon progressive opening of the door, exerts an increasing retaining force against the door.

14. The door jig assembly as described in claim 13, said spring deflecting portions further comprising first and second elongated and biasing straps extending between said spring biasing cage portion and said second end.

15. The door jig assembly as described in claim 14, further comprising said first and second straps overlapping at a first location within said spring biasing cage, said straps diverging subsequent to said first location to define a seating location of said pin in the door closed position.

16. The door jig assembly as described in claim 15, said straps overlapping at a second location along said predetermined length of said elongated body.

17. The door jig assembly as described in claim 13, further comprising a plurality of opposing and undulating portions defined at locations along said predetermined length of said elongated body, said undulating portions defining seating locations for said pin in the door opening direction.

18. The door jig assembly as described in claim 13, further comprising a plurality of axially spaced apertures defined along said elongated body, proximate said first end, and defining additional and hingedly securing locations for said tab.

19. The door jig assembly as described in claim 13, an apertured portion being defined within the inner facing door edge, proximate said first and second engaging locations of said mounting studs, and through which a selected portion of said elongated body extends.

20. A door jig assembly for use with a vehicle, the vehicle including a door having an inner facing edge and which is hingedly connected to a vehicle pillar forming a part of a vehicle door frame, the door further capable of being pivoted about the hinges and between opened and closed positions relative to the pillar, said jig assembly comprising:
an elongated body constructed of a stamped spring steel material and having a first end and a second end;
a tab hingedly securing to said first end of said elongated body and fixedly engaging to the vehicle pillar;
a pin assembly including a pair of extending mounting studs pivotally secured to the inner facing edge of the vehicle door and so that a pin extending therebetween is translatable in guided fashion in one of first and second directions along said elongated body and upon opening and closing of the door;
a pair of first and second elongate extending straps overlapping at a first location proximate to a spring biasing cage portion disposed at an intermediate location along the elongated body and which, upon rotating the vehicle door to the closed position, establishes a seating location for said pin which exerts a specified holding force of the door against the vehicle frame; and
said straps overlapping at a second location extending along a predetermined length of said elongated body towards said second end, said straps further defining spring deflecting portions corresponding to a travel direction of said translatable pin and which, upon progressive opening of the door, exerts an increasing retaining force against the door.
